(19) United States
(12) Patent Application Publication
(10) Pub. No.: US 2017/0067380 A1
(43) Pub. Date: Mar. 9, 2017

(54) Exhaust Assembly

(71) Applicant: John Cantrell, Los Gatos, CA (US)

(72) Inventor: John Cantrell, Los Gatos, CA (US)

(21) Appl. No.: 15/257,473

(22) Filed: Sep. 6, 2016

Related U.S. Application Data
(60) Provisional application No. 62/214,324, filed on Sep. 4, 2015.

(51) Int. Cl. F01N 1/16; G10K 11/16

(52) U.S. Cl. CPC F01N 1/168; G10K 11/161

(57) ABSTRACT

An exhaust assembly. The exhaust assembly includes a housing having a first end that attaches to an exhaust pipe of a vehicle, such as a motorcycle, and a second end that can discharge exhaust from the engine of the vehicle. A baffle is disposed within the housing that is operated by an actuator. In one embodiment, the actuator is a hand operated lever that can move between a first actuation point and a second actuation point, thereby causing the baffle to move between a closed position and an open position.

### CROSS REFERENCE TO RELATED APPLICATION

This application claims the benefit of U.S. Provisional Application No. 62/214,324 filed on Sep. 4, 2015. The above identified patent application is herein incorporated by reference in its entirety to provide continuity of disclosure.

### BACKGROUND OF THE INVENTION

### Field of the Invention

The present invention relates to an exhaust assembly. More specifically, the present invention relates to an exhaust assembly having an actuator that causes a baffle to alter positions and produce a sound upon opening and closing.

Motorcycles and other vehicles utilize internal combustion engines to drive the vehicle, and evacuate the spent exhaust gas through an exhaust pipe. As the exhaust gas passes through the exhaust pipe, sound is emitted as pressure waves form from the alternating low and high air pressure. The result is a loud, thunderous exhaust tone that many motorcycle enthusiasts find desirable. The loud exhaust noise is in fact a signature effect of some types of motorcycles.

However, there are several problems with loud exhausts. For example, many municipalities have passed noise ordinances defining a maximum sound level permitted for operation of a moving vehicle. Many motorcycles exceed this sound level and may therefore not be legally operated within the particular municipality. Thus, a motorcycle may be operated in many areas yet prohibited from a few areas which have enacted more strict noise ordinances.

Devices have been disclosed in the known art that relate to exhaust baffles and exhaust assemblies. These devices in the known art have several drawbacks. For example, one solution is to add a muffling device to reduce the exhaust noise so that it complies with the most restrictive noise ordinance. Though these conventional muffling devices may reduce exhaust noise, they also impede the flow of exhaust gas through the exhaust system. When spent gases cannot flow freely through the exhaust system because of restrictions, they cause exhaust gases to back up into the combustion chamber the higher RPM range. Since the gases cannot escape at the proper velocity, the engine needs to work harder without yielding greater power.

In light of the devices disclosed in the known art, it is submitted that the present invention substantially diverges design elements from the prior art and consequently it is clear that there is a need in the art for an improvement to existing exhaust assembly devices. In this regard the instant invention substantially fulfills these needs.

### SUMMARY OF THE INVENTION

In view of the foregoing disadvantages inherent in the known types of exhaust assemblies now present in the known art, the present invention provides a new exhaust assembly wherein the same can be utilized for providing convenience for the user when driving a vehicle.

It is therefore an object of the present invention to provide a new and improved exhaust assembly comprising a housing having an open first end that is in fluid communication with an opposing second end. The housing removably at to a distal end of a preexisting exhaust pipe of a vehicle via a collar. The second end of the housing is configured to discharge exhaust from an engine of a vehicle. A baffle is disposed within the housing, wherein the baffle is operably connected with a linkage, which in turn is operably connected to an actuator. In one embodiment, the actuator is a hand operated lever that is attachable to a handlebar of a vehicle. The actuator is configured to actuate the baffle between an open position and a closed position. In this way, the sound profile of the exhaust assembly is alterable by the position of the baffle.

It is another object of the present invention to provide an exhaust assembly having a hand operated actuator that opens and closes the baffle to alter the sound produced by the exhaust.

Another object of the present invention is to provide an exhaust assembly that allows a user to selectively obtain the desired sound and power, while also having the additional benefit of an enhanced throttle response.

Another object of the present invention is to provide an exhaust assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the exhaust assembly.

FIG. 2 shows a cross sectional view of the exhaust assembly in a closed position taken along line 2-2 of FIG. 1.

FIG. 3 shows a close up cross sectional view of e exhaust assembly in an open position.

### DETAILED DESCRIPTION OF THE INVENTION

Reference is made herein to the attached drawings. Like reference numerals are used throughout the drawings to depict like or similar elements of the exhaust assembly. For the purposes of presenting a brief and clear description of the present invention, the preferred embodiment will be discussed as used for manipulating exhaust as it exits from a vehicle. The figures are intended for representative purposes only and should not be considered to be limiting in any respect,

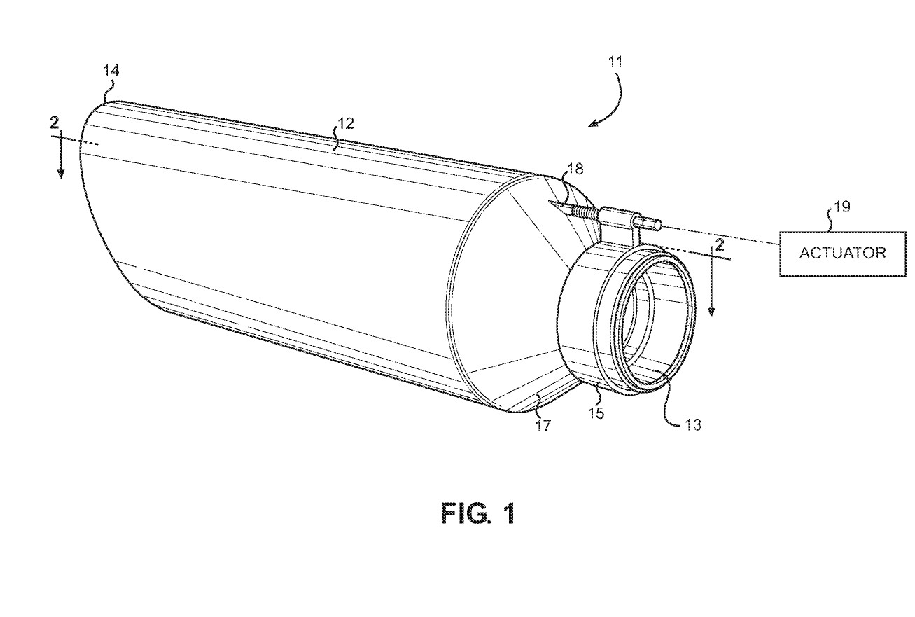

Referring now to FIG. 1, there is shown a perspective view of the exhaust assembly. The exhaust assembly 11 provides a way of altering and producing sound from exhaust air (henceforth “exhaust”) that is discharged from a vehicle engine. The exhaust assembly 11 comprises a housing 12 having an open first end 13 that is in fluid communication with an opposing second end 14. The first end 13 is configured to removably affix to a distal end of a preexisting exhaust pipe of a vehicle via a collar 15. In a preferred embodiment, the housing 12 is cylindrical. However, in alternative embodiments, the housing 12 may include other tubular shapes. The collar 15 may include fastener for securement thereof. In the shown embodiment, the collar 15 secures the first end 13 of the housing 12 over the preexisting exhaust pipe, such that they are in fluid communication. In the shown embodiment be housing 12 includes a tapered section 17, wherein the second end 14 has a diameter greater than the first end 13. In one embodiment, the tapered section 17 assists with the production of sound at a desirable frequency. The shape of the housing 12 contributes to the overall sound profile of the exhaust assembly 11.

The second end 14 of the housing 12 is configured to discharge exhaust from an engine of a vehicle. A baffle (not shown) is disposed within the housing 12, wherein the baffle is operably connected with a linkage 18, which is in turn operably connected to an actuator 19. In one embodiment, the actuator 19 is a hand operated lever that is attachable to a handlebar of a vehicle. In other embodiments, the actuator 19 includes a motor. The actuator 19 is configured to actuate the baffle bets ween an open position and a closed position.

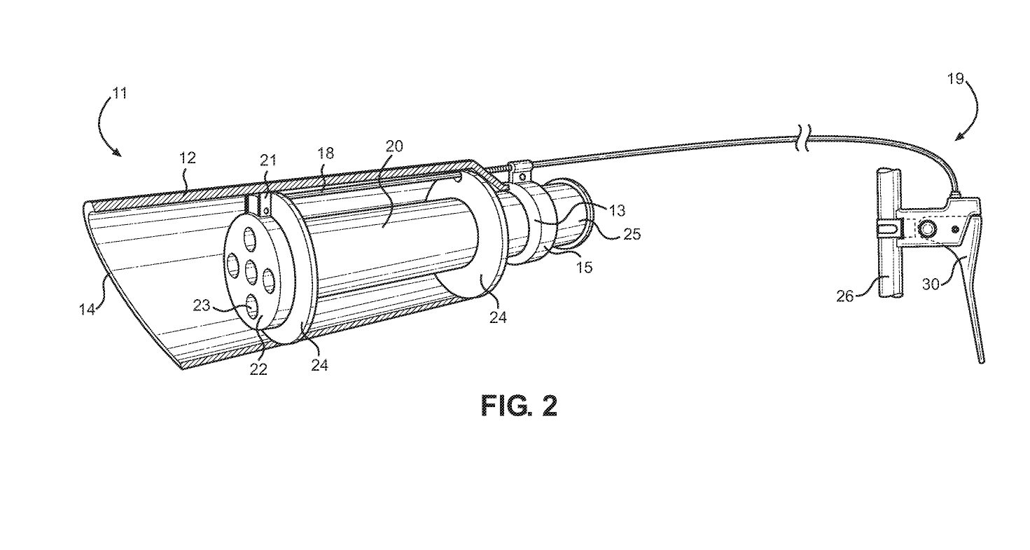

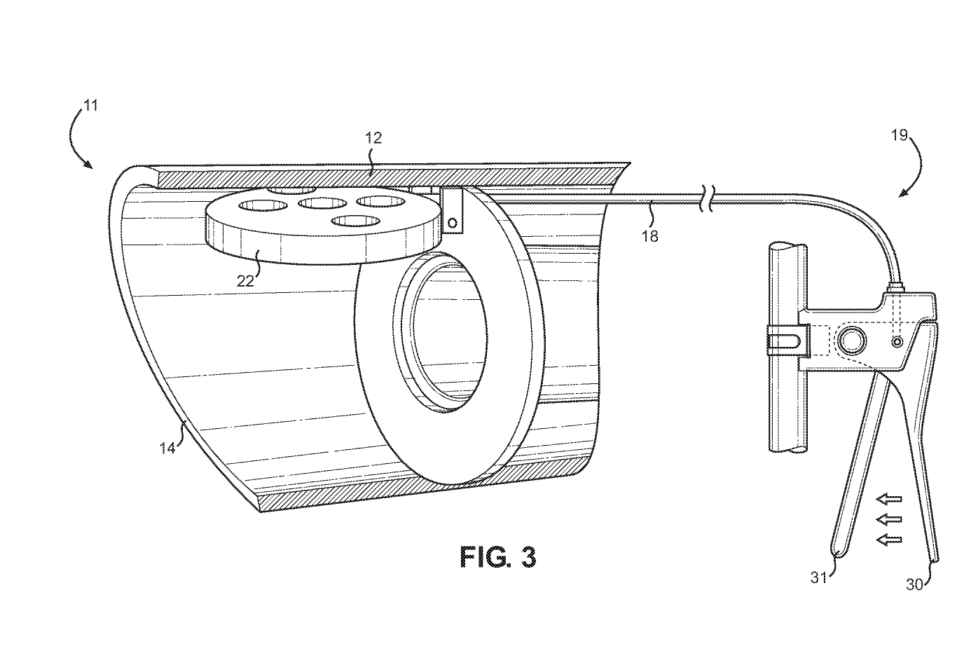

Referring now to FIGS. 2 and 3, there is shown a cross sectional view of the exhaust assembly in a closed position taken along line 2-2 of FIG. 1 and a close up cross sectional view of the exhaust assembly in an open position, respectfully. In FIG. 2, the baffle 22 is in the closed position and the actuator 19 is a hand actuated lever mounted to a handlebar 26 of a motorcycle. The linkage 18 runs from the actuator 19 to the baffle 22. In a preferred embodiment, the linkage 18 is a cable. The actuator 19 includes a first actuation point 30 and a second actuation point 31, wherein actuation of the actuator 19 from the first actuation point 30 to the second actuation point 31 causes the baffle 22 to pivot to into an open position and actuation of the actuator 19 back to the first actuation point 30 pivots the baffle into a closed position. In the closed position, the baffle 22 is positioned perpendicular to the flow of exhaust through the housing 12, from the first end 13 to the second end 14. In this way, the baffle 22 is in the closed position it dampens the overall sound of the exhaust. In the shown embodiment, the hand operated lever is also operably connected to the clutch, such that actuation of the hand operated lever operates both the clutch and the baffle 22. In other embodiments the hand operated lever is also operably connected to the brake. In yet another embodiment, the hand operated lever is operated independent of other function.

The baffle 22 includes one or more apertures 23 configured to allow some of the vehicle's exhaust to flow through the housing 12. The apertures 23 are circular and arranged in a cross pattern. In alternative embodiments, the shapes and position of the apertures 23 may be varied. In this way, the sound profile, the frequency and amplitude, of the exhaust assembly 11 can be customizable to each vehicle. Further, the apertures 23 prevent a buildup of pressure within the preexisting exhaust pipe of the vehicle that can lead to decreased engine efficiency and performance.

In one embodiment, the linkage 18 is biased in tension, such that the baffle 22 remains in the closed position until the actuator 19 is repositioned into the second actuation point 31. Upon actuating the actuator 19 to the second actuation point 31, the actuator 19 causes the baffle 22 to pivot to an open position. In the open position, the baffle 22 is oriented parallel to the flow of exhaust through the housing 12, from the first end 13 to the second end 14.

In one embodiment, the housing 12 includes an interior tube 20 and a frame member 24, wherein the interior tube 20 is in fluid communication with the first end 13 of the housing 12. The interior tube 20 extends into the housing 12 and terminates prior to the second end 14 of the housing 12. In one embodiment, the interior tube 20 is an extension of a preexisting exhaust pine 25 of a vehicle. The frame member 24 is a flange that is concentric with the interior tube 20 and affixed to the housing 12 along an interior side. In this way, the frame member 24 is configured to maintain a connection between the housing 12 and the interior tube 20. The baffle 22 is pivotally connected to the frame member 24 via a hinge 21. The actuation of the actuator 19 causes the baffle 22 to pivot away from the frame member 24 to allow unobstructed fluid communication through the housing 12.

As the exhaust flows through the housing 12, the exhaust assembly 11 vibrates and produces a sound. The opening and closing of the baffle 22 via the actuator 19, alters the sound profile of the exhaust assembly 11 by changing the way the exhaust flows through from the first end 13 to the second end 14. In this way, the exhaust assembly 11 alters and produces sound from the exhaust that is discharged from a vehicle engine.

It is therefore submitted that the instant invention has been shown and described in what is considered to be the most practical and preferred embodiments. It is recognized, however, that departures may be made within the scope of the invention and that obvious modifications will occur to a person skilled it the art. With respect to the above description there, it is to be realized that the optimum dimensional relationships for the parts of the invention, to include variations n size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted within the scope of the invention.

I claim:

1. An exhaust assembly, comprising:
a housing including an open first end and an opposing second end;
the first end configured to removably affix to a distal end of an exhaust pipe via a collar;
the second end configured to discharge exhaust from an engine of a vehicle;
a baffle disposed within the housing, the baffle being operably connected to an actuator by a linkage;
the actuator including a first actuation point and a second actuation point;
wherein actuation of the actuator to the first actuation point causes the baffle to pivot to a closed position;
wherein actuation of the actuator to the second actuation point causes the baffle to pivot to an open position.

2. The exhaust assembly of claim 1, wherein:
the baffle is configured to allow exhaust to flow unobstructed through the housing in the open position;
the baffle partially obstructs exhaust from flowing through the housing in the closed position.

3. The exhaust assembly of claim 1, wherein:
the linkage is biased in tension, such that the baffle is biased in the closed position.

4. The exhaust assembly of claim 1, wherein:
linkage is biased in tension, such that the baffle is biased in the open position.

5. The exhaust assembly of claim 1, wherein:
the collar further comprises a support, the support configured to receive the linkage therethrough.

6. The exhaust assembly of claim 1, wherein:
the housing comprises an interior tube and a frame, the frame configured to maintain a connection between the housing and an exhaust pipe.

7. The exhaust assembly of claim 1, wherein:
the actuator is a lever configured to be hand operated by a user, wherein the actuator being disposed on a handlebar of a vehicle.

8. The exhaust assembly of claim 1, wherein:
the actuator a motor including a control configured to be hand operated by a user, the control being disposed on a handlebar of a vehicle.

9. The exhaust assembly of claim 1, wherein:
the baffle comprises one or more apertures configured to allow a vehicle's exhaust to pass therethrough.

10. The exhaust assembly of claim 1, wherein:
the housing includes a tapered section, wherein the tapered section causes the second end to have a diameter greater than the first end.
